(19) United States
(12) Patent Application Publication
(10) Pub. No.: US 2025/0304766 A1
(43) Pub. Date: Oct. 2, 2025

(54) RUBBER COMPOSITION FOR HOSE, AND HOSE

(71) Applicant: THE YOKOHAMA RUBBER CO., LTD., HIRATSUKA-SHI (JP)

(72) Inventor: Koki SUGIHARA, HIRATSUKA SHI (JP)

(21) Appl. No.: 19/086,548

(22) Filed: Mar. 21, 2025

(30) Foreign Application Priority Data
Apr. 2, 2024 (JP) 2024-059548

(51) Int. Cl. C08K 5/14; C08K 3/04; C08K 3/22; F16L 11/04

(52) U.S. Cl. CPC C08K 5/14; C08K 3/04; C08K 3/22; F16L 11/04; C08K 2003/222

(57) ABSTRACT

A rubber composition for a hose excellent durability under a low temperature condition includes a hydrogenated acrylonitrile butadiene rubber having an acrylonitrile content of 24 mass % or less, carbon black, and peroxide, and a content of the peroxide is 1.0 part by mass or more and less than 2.4 parts by mass per 100 parts by mass of the hydrogenated acrylonitrile butadiene rubber, and a content of the magnesium oxide is 0 parts by mass or more and less than 10.0 parts by mass per 100 parts by mass of the hydrogenated acrylonitrile butadiene rubber, or the content of the peroxide is from 1.0 to 3.5 parts by mass per 100 parts by mass of the hydrogenated acrylonitrile butadiene rubber, and the content of the magnesium oxide is from 0 to 3.0 parts by mass per 100 parts by mass of the hydrogenated acrylonitrile butadiene rubber.

### TECHNICAL FIELD

The present invention relates to a rubber composition for a hose and a hose.

### BACKGROUND ART

Since an automobile is used not only in a warm environment but also in a cold region, a power steering hose to be installed in the automobile is required to have robust low-temperature performance.

In the known art, a rubber composition for a hose and a hose with excellent oil resistance and low-temperature performance have been proposed (for example, Patent Document 1).

### CITATION LIST

### Patent Document

Patent Document 1: JP 2022-131899 A

### SUMMARY OF INVENTION

### Technical Problem

As a result of studying the rubber composition for a hose and the hose disclosed in Patent Document 1, the present inventor has found that, there is room for further improvement in durability of the hose having a constituent member formed of a cured product of the rubber composition for a hose under a low temperature condition (that is, toughness of the cured product obtained from the hose or the rubber composition under a low temperature condition).

Thus, an object of the present invention is to provide a rubber composition for a hose that can be a cured product having excellent durability under a low temperature condition.

Another object of the present invention is to provide a hose having excellent durability under a low temperature condition.

### Solution to Problem

As a result of intensive studies to solve the above-described issues, the present inventor has found that, in a rubber composition for a hose containing a hydrogenated acrylonitrile butadiene rubber having an acrylonitrile content of 24 mass % or less, carbon black, and peroxide, in a case where a content of the peroxide is 1.0 parts by mass or more and less than 2.4 parts by mass per 100 parts by mass of the hydrogenated acrylonitrile butadiene rubber and a content of the magnesium oxide is 0 parts by mass or more and less than 10.0 parts by mass per 100 parts by mass of the hydrogenated acrylonitrile butadiene rubber, or in a case where the content of the peroxide is from 1.0 to 3.5 parts by mass per 100 parts by mass of the hydrogenated acrylonitrile butadiene rubber and the content of the magnesium oxide is from 0 to 3.0 parts by mass per 100 parts by mass of the hydrogenated acrylonitrile butadiene rubber, a desired effect can be achieved.

That is, specifically, the present invention is to solve the issues described above by the following configurations.

[1] A rubber composition for a hose, containing: a hydrogenated acrylonitrile butadiene rubber having an acrylonitrile content of 24 mass % or less; a carbon black; and a peroxide, wherein a content of the peroxide is 1.0 part by mass or more and less than 2.4 parts by mass per 100 parts by mass of the hydrogenated acrylonitrile butadiene rubber, and a content of magnesium oxide is 0 parts by mass or more and less than 10.0 parts by mass per 100 parts by mass of the hydrogenated acrylonitrile butadiene rubber.

In the present specification, the rubber composition for a hose described in [1] above may be referred to as “first rubber composition according to the present invention”.

[2] A rubber composition for a hose, containing: a hydrogenated acrylonitrile butadiene rubber having an acrylonitrile content of 24 mass % or less; a carbon black; and a peroxide, wherein a content of the peroxide is from 1.0 to 3.5 parts by mass per 100 parts by mass of the hydrogenated acrylonitrile butadiene rubber, and a content of magnesium oxide is from 0 to 3.0 parts by mass per 100 parts by mass of the hydrogenated acrylonitrile butadiene rubber.

In the present specification, the rubber composition for a hose described in [2] above may be referred to as “second rubber composition according to the present invention”.

In addition, the “first rubber composition according to the present invention” and the “second rubber composition according to the present invention” may be collectively referred to as the “rubber composition of the present invention”.

[3] The rubber composition for a hose according to [2], wherein the content of the peroxide is from 1.0 to 2.4 parts by mass per 100 parts by mass of the hydrogenated acrylonitrile butadiene rubber.

[4] A hose produced by using the rubber composition for a hose according to any one of [1] to [3].

[5] The hose according to [4], which is a hose for an automobile.

[6] The hose according to [4] or [5], which is piping of a power steering system for an automobile.

### Advantageous Effects of Invention

According to the present invention, it is possible to provide a rubber composition for a hose that can be a cured product having excellent durability under a low temperature condition.

The present invention can also provide a hose having excellent durability under a low temperature condition.

### BRIEF DESCRIPTION OF DRAWINGS

FIG. 1 is a schematic perspective view illustrating an example of a hose of the present invention with each layer cut out.

### DESCRIPTION OF EMBODIMENTS

The present invention is described in detail below.

Although the components described below may be described based on representative embodiments of the present invention, the present invention is not limited to such embodiments.

In the present specification, a numerical range indicated using “(from) . . . to . . . ” includes the former number as the lower limit value and the latter number as the upper limit value.

In the present specification, each component can use a single component alone, or a combination of two or more types.

In the present specification, in a case where a component uses a combination of two or more types, a “content” of the component means a total content of these two or more types unless otherwise noted.

In the present specification, the production method of each component is not particularly limited unless otherwise noted. Examples of the method include a known method.

In the present specification, the cases where durability under a low temperature condition is more excellent may be referred to as “the effect of the present invention is more excellent”.

The reason why the rubber composition of the present invention can solve the problem of the present invention is not necessarily clear, but the present inventors presume as follows. The following presumption is not to limit the mechanism by which the effect is obtained. In other words, a case where an effect is obtained by a mechanism other than the mechanism described below is also included in the scope of the present invention.

First, in a cured product of a rubber composition, magnesium oxide generally has no reinforcing property for a rubber component. Thus, in a case of the above-described cured product with a large amount of magnesium oxide present therein, when impact is applied to the cured product under a low temperature condition, the magnesium oxide, which can serve as a weak point in the cured product, may become a starting point for fracture and make the cured product brittle.

On the other hand, since the rubber composition of the present invention does not contain magnesium oxide or the content of magnesium oxide in the rubber composition of the present invention is in a predetermined range, magnesium oxide is not contained in the cured product obtained from the rubber composition of the present invention, or the content of magnesium oxide in the cured product is small, so that the cured product is less likely to be broken and has improved toughness even when impact is applied to the cured product obtained from the rubber composition of the present invention under a low temperature condition, and therefore the rubber composition of the present invention is considered to have excellent durability under the low temperature condition.

In the rubber composition of the present invention, when the content of peroxide is within a predetermined range, a crosslinking density of the rubber in the cured product obtained from the rubber composition of the present invention is smaller than that when the peroxide is contained in an amount exceeding the above range; therefore, even when impact is applied to the cured product obtained from the rubber composition of the present invention under a low temperature condition, the cured product is less likely to be broken, the toughness is improved, and therefore, durability under the low temperature condition is considered to be excellent.

### First Rubber Composition According to the Present Invention

The first rubber composition according to the present invention will be described below.

A rubber composition for a hose according to the present invention (the first rubber composition according to the present invention) is a rubber composition for a hose, containing a hydrogenated acrylonitrile butadiene rubber having an acrylonitrile content of 24 mass % or less, a carbon black, and a peroxide, wherein a content of the peroxide is 1.0 part by mass or more and less than 2.4 parts by mass per 100 parts by mass of the hydrogenated acrylonitrile butadiene rubber, and a content of magnesium oxide is 0 parts by mass or more and less than 10.0 parts by mass per 100 parts by mass of the hydrogenated acrylonitrile butadiene rubber.

### Hydrogenated Acrylonitrile Butadiene Rubber

The first rubber composition according to the present invention contains a hydrogenated acrylonitrile butadiene rubber (HNBR) having an acrylonitrile content (AN content) of 24 mass % or less. In the present specification, the hydrogenated acrylonitrile butadiene rubber having an acrylonitrile content of 24 mass % or less is also referred to as “the HNBR”.

The HNBR contained in the first rubber composition according to the present invention is a hydrogenated product of a copolymer of acrylonitrile and butadiene.

The HNBR has an acrylonitrile group.

The hydrogenation of the HNBR is a hydrogenation in a main chain, and the hydrogenation may be partial hydrogenation or full hydrogenation.

### Acrylonitrile Content

In the first rubber composition according to the present invention, the acrylonitrile content (AN content) of the HNBR is 24 mass % or less in the HNBR.

The AN content of the HNBR is preferably from 18 to 22 mass % in the HNBR from the viewpoint of more excellent effect of the present invention and excellent oil resistance.

In an embodiment of the present invention, the acrylonitrile content of the HNBR can be measured in accordance with the semimicro Kjeldahl method based on JIS K 6384:2016.

### (Hydrogenation Percentage)

A hydrogenation percentage of the HNBR is preferably 95 to 100% of a double bond (present in a repeating unit derived from butadiene) of the NBR before hydrogenation from the viewpoint of more excellent effect of the present invention.

In the present invention, the hydrogenation percentage of the HNBR can be measured in accordance with JIS K 6235:2006.

The first rubber composition according to the present invention preferably contains only the HNBR as the rubber component from the viewpoint of more excellent effect of the present invention and excellent oil resistance.

### (Content of the HNBR)

The content of the HNBR is preferably from 30 to 70 mass % in a total amount of the first rubber composition according to the present invention from the viewpoint of more excellent effect of the present invention and excellent oil resistance.

The first rubber composition according to the present invention preferably contains substantially no alloyed HNBR from the viewpoint of more excellent effect of the present invention. The rubber composition according to the present invention containing substantially no alloyed HNBR means the amount of the alloyed HNBR being from 0 to 1.0 mass % in the total amount of the rubber composition according to the present invention.

### Carbon Black

The first rubber composition according to the present invention contains carbon black. The carbon black is not particularly limited in an embodiment of the present invention.

### (Nitrogen Adsorption Specific Surface Area of Carbon Black)

The nitrogen adsorption specific surface area of the carbon black is preferably from 5 to 50 m²/g from the perspective of exhibiting superior effect of the present invention.

In the present invention, the nitrogen adsorption specific surface area of the carbon black can be measured in accordance with JIS K 6217-2:2017.

### (Dibutyl Phthalate Oil Absorption of Carbon Black)

From the viewpoint of more excellent effect of the present invention, the dibutyl phthalate oil absorption of the carbon black is preferably from 25 to 130 mL/100 g, and more preferably from 50 to 120 mL/100 g.

The dibutyl phthalate oil absorption of the carbon black can be measured in accordance with JIS K 6217-4:2017.

Examples of the carbon black include carbon blacks of Fine Thermal Furnace (FTF) grade, Fast Extruding Furnace (FEF) grade, General Purpose Furnace (GPF) grade, and Semi-Reinforcing Furnace (SRF) grade.

A single carbon black can be used or a combination of two or more carbon blacks can be used.

From the viewpoint of more excellent effect of the present invention, the combination of carbon blacks is preferably a combination of FEF grade carbon black and SRF grade carbon black.

### (Content of Carbon Black)

From the viewpoint of more excellent effect of the present invention, the content of the carbon black (when two or more types of carbon blacks are used in combination, total amount thereof) is preferably from 40 to 150 parts by mass, and more preferably from 80 to 120 parts by mass per 100 parts by mass of the hydrogenated acrylonitrile butadiene rubber having an acrylonitrile content of 24 mass % or less.

### Peroxide

The first rubber composition according to the present invention contains peroxide.

The peroxide contained in the first rubber composition according to the present invention is not particularly limited as long as it is a peroxide capable of extracting protons from HNBR.

Examples of the peroxide include benzoyl peroxide, dicumyl peroxide, di-t-butyl peroxide, t-butylcumyl peroxide, methyl ethyl ketone peroxide, cumene hydroperoxide, 2,5-dimethyl-2,5-di(t-butylperoxy)hexane, 2,5-dimethyl-2,5-di(benzoylperoxy)hexane, 1,3-bis(t-butylperoxypropyl)benzene, di(t-butylperoxydiisopropyl)benzene, t-butylperoxybenzene, 2,4-dichlorobenzoylperoxide, and 1,1-dibutylperoxy-3,3,5-trimethylsiloxane.

From the viewpoint of being capable of functioning as a crosslinking agent and more excellent effect of the present invention, the peroxide preferably contains an organic peroxide having a plurality of peroxy groups and more preferably contains at least one selected from the group consisting of di-t-butylperoxide, 2,5-dimethyl-2,5-di(t-butylperoxy)hexane, 2,5-dimethyl-2,5-di(benzoylperoxy)hexane, 1,3-bis(t-butylperoxypropyl)benzene, and di(t-butylperoxydiisopropyl)benzene.

### Content of Peroxide

In the first rubber composition according to the present invention, the content of peroxide is 1.0 part by mass or more and less than 2.4 parts by mass per 100 parts by mass of the hydrogenated acrylonitrile butadiene rubber having an acrylonitrile content of 24 mass % or less. When the content of peroxide in the first rubber composition according to the present invention is 1.0 part by mass or more, the hydrogenated acrylonitrile butadiene rubber can be crosslinked.

In the first rubber composition according to the present invention, the content of peroxide is preferably from 1.1 to 2.2 parts by mass per 100 parts by mass of the hydrogenated acrylonitrile butadiene rubber having an acrylonitrile content of 24 mass % or less, from the viewpoint of more excellent effect of the present invention.

The peroxide used in the first rubber composition according to the present invention may be a mixture of peroxide and silica. Examples of a commercially available product of the mixture of peroxide and silica include Perkadox 14-40 (available from AKZO).

When the mixture is used as peroxide in the first rubber composition according to the present invention, the content of peroxide contained in the first rubber composition according to the present invention refers to a net content of peroxide in the mixture.

### Content of Magnesium Oxide

In the first rubber composition according to the present invention, the content of magnesium oxide is 0 parts by mass or more and less than 10.0 parts by mass per 100 parts by mass of the hydrogenated acrylonitrile butadiene rubber having an acrylonitrile content of 24 mass % or less.

In the first rubber composition according to the present invention, magnesium oxide is an optional component. Therefore, in the first rubber composition according to the present invention, when the first rubber composition according to the present invention does not contain magnesium oxide, or when the first rubber composition according to the present invention contains magnesium oxide, the content of magnesium oxide is more than 0 parts by mass and less than 10.0 parts by mass per 100 parts by mass of the hydrogenated acrylonitrile butadiene rubber.

The content of magnesium oxide is preferably from 0 to 2.0 parts by mass, more preferably from 0 to 1.0 part by mass, and still more preferably 0 parts by mass per 100 parts by mass of the hydrogenated acrylonitrile butadiene rubber having an acrylonitrile content of 24 mass % or less, from the viewpoint of more excellent effect of the present invention.

When the first rubber composition according to the present invention contains magnesium oxide, the content of magnesium oxide can be more than 3.0 parts by mass per 100 parts by mass of the hydrogenated acrylonitrile butadiene rubber having an acrylonitrile content of 24 mass % or less.

### (Magnesium Oxide)

When the first rubber composition according to the present invention contains magnesium oxide, the magnesium oxide (MgO) is not particularly limited.

When the first rubber composition according to the present invention contains magnesium oxide, the magnesium oxide can function as an adhesion imparting agent.

### Second Rubber Composition According to the Present Invention

The rubber composition of the present invention (the second rubber composition according to the present invention) is a rubber composition for a hose, containing a hydrogenated acrylonitrile butadiene rubber having an acrylonitrile content of 24 mass % or less, a carbon black, and a peroxide, wherein a content of the peroxide is from 1.0 to 3.5 parts by mass per 100 parts by mass of the hydrogenated acrylonitrile butadiene rubber, and a content of magnesium oxide is from 0 to 3.0 parts by mass per 100 parts by mass of the hydrogenated acrylonitrile butadiene rubber.

### Hydrogenated Acrylonitrile Butadiene Rubber

Since the hydrogenated acrylonitrile butadiene rubber in which an acrylonitrile content in the second rubber composition according to the present invention is 24 mass % or less is the same as the hydrogenated acrylonitrile butadiene rubber in which the acrylonitrile content in the first rubber composition according to the present invention is 24 mass % or less, the description on the hydrogenated acrylonitrile butadiene rubber in which the acrylonitrile content in the second rubber composition according to the present invention is 24 mass % or less is omitted here. In the present specification, the hydrogenated acrylonitrile butadiene rubber having an acrylonitrile content of 24 mass % or less is also referred to as “the HNBR”.

### Carbon Black

Since the carbon black contained in the second rubber composition according to the present invention is the same as the carbon black contained in the first rubber composition according to the present invention, the description of the carbon black contained in the second rubber composition according to the present invention is omitted here.

### Peroxide

The second rubber composition according to the present invention contains peroxide.

The peroxide contained in the second rubber composition according to the present invention is not particularly limited as long as it is a peroxide capable of extracting protons from HNBR.

Examples of the peroxide include benzoyl peroxide, dicumyl peroxide, di-t-butyl peroxide, t-butylcumyl peroxide, methyl ethyl ketone peroxide, cumene hydroperoxide, 2,5-dimethyl-2,5-di(t-butylperoxy)hexane, 2,5-dimethyl-2,5-di(benzoylperoxy)hexane, 1,3-bis(t-butylperoxypropyl)benzene, di(t-butylperoxydiisopropyl)benzene, t-butylperoxybenzene, 2,4-dichlorobenzoylperoxide, and 1,1-dibutylperoxy-3,3,5-trimethylsiloxane.

From the viewpoint of being capable of functioning as a crosslinking agent and more excellent effect of the present invention, the peroxide preferably contains an organic peroxide having a plurality of peroxy groups and more preferably contains at least one selected from the group consisting of di-t-butylperoxide, 2,5-dimethyl-2,5-di(t-butylperoxy)hexane, 2,5-dimethyl-2,5-di(benzoylperoxy)hexane, 1,3-bis(t-butylperoxypropyl)benzene, and di(t-butylperoxydiisopropyl)benzene.

### Content of Peroxide

In the second rubber composition according to the present invention, the content of peroxide is from 1.0 to 3.0 parts by mass per 100 parts by mass of the hydrogenated acrylonitrile butadiene rubber having an acrylonitrile content of 24 mass % or less. When the content of peroxide in the second rubber composition according to the present invention is 1.0 parts by mass or more, the hydrogenated acrylonitrile butadiene rubber can be crosslinked.

In the second rubber composition according to the present invention, the content of peroxide is preferably from 1.0 to 2.4 parts by mass, and more preferably from 1.1 to 2.2 parts by mass per 100 parts by mass of the hydrogenated acrylonitrile butadiene rubber having an acrylonitrile content of 24 mass % or less, from the viewpoint of more excellent effect of the present invention.

The peroxide used in the second rubber composition according to the present invention may be a mixture of peroxide and silica. Examples of a commercially available product of the mixture of peroxide and silica include Perkadox 14-40 (available from AKZO).

When the mixture is used as peroxide in the second rubber composition according to the present invention, the content of peroxide contained in the second rubber composition according to the present invention refers to the net content of peroxide in the mixture.

### Content of Magnesium Oxide

In the second rubber composition according to the present invention, the content of magnesium oxide is from 0 to 3.0 parts by mass per 100 parts by mass of the hydrogenated acrylonitrile butadiene rubber having an acrylonitrile content of 24 mass % or less.

In the second rubber composition according to the present invention, magnesium oxide is an optional component. Therefore, in the second rubber composition according to the present invention, when the second rubber composition according to the present invention does not contain magnesium oxide, or when the second rubber composition according to the present invention contains magnesium oxide, the content of magnesium oxide is more than 0 parts by mass and 3.0 parts by mass or less per 100 parts by mass of the hydrogenated acrylonitrile butadiene rubber.

The content of magnesium oxide is preferably from 0 to 2.0 parts by mass, more preferably from 0 to 1.0 part by mass, and still more preferably 0 parts by mass per 100 parts by mass of the hydrogenated acrylonitrile butadiene rubber having an acrylonitrile content of 24 mass % or less, from the viewpoint of more excellent effect of the present invention.

### (Magnesium Oxide)

When the second rubber composition according to the present invention contains magnesium oxide, the magnesium oxide (MgO) is not particularly limited.

When the second rubber composition according to the present invention contains magnesium oxide, the magnesium oxide can function as an adhesion imparting agent.

In the present specification, the following matters are common to the first rubber composition according to the present invention and the second rubber composition according to the present invention unless otherwise specified, and thus the following matters will be described as the rubber composition of the present invention.

### (Additives)

The rubber composition of the present invention can further contain additives such as an anti-aging agent, an antioxidant, an antistatic agent, a flame retardant, a crosslinking aid such as zinc oxide, stearic acid, a co-crosslinking agent, silica, and an additive such as a plasticizer, in a range that does not impair the object of the present invention. The additives are not particularly limited. Examples thereof include known ones. The content of each additive is not particularly limited and can be appropriately selected.

### Co-Crosslinking Agent

The co-crosslinking agent that can be further contained in the rubber composition of the present invention is not particularly limited as long as it is a compound that can crosslink HNBR. Examples of the co-crosslinking agent include triallyl isocyanurate and diallyl compounds.

When the rubber composition of the present invention further contains a co-crosslinking agent, the co-crosslinking agent preferably contains triallyl isocyanurate and/or a diallyl compound, and more preferably contains triallyl isocyanurate and a diallyl compound, from the viewpoint of more excellent effect of the present invention.

### Triallyl Isocyanurate

The triallyl isocyanurate that can be contained in the rubber composition of the present invention is a compound having the following structure.

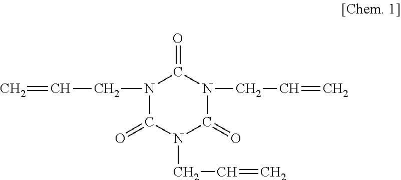 [SMILES: C=CCn1c(=O)n(CC=C)c(=O)n(CC=C)c1=O]

When the rubber composition of the present invention further contains triallyl isocyanurate, the content of triallyl isocyanurate is preferably 1.9 parts by mass or more, more preferably from 2.5 to 5.0 parts by mass, and still more preferably from 3.0 to 4.0 parts by mass per 100 parts by mass of the hydrogenated acrylonitrile butadiene rubber having an acrylonitrile content of 24 mass % or less, from the viewpoint of more excellent effect of the present invention.

### Diallyl Compound

The rubber composition according to an embodiment of the present invention preferably further contains a diallyl compound from the perspective of exhibiting superior effect of the present invention and achieving excellent elongation of the resulting rubber.

The diallyl compound is not particularly limited as long as the diallyl compound is a compound having two allyl groups. Examples thereof include aromatic compounds having two allyl groups such as diallyl phthalate.

From the perspective of exhibiting superior effect of the present invention and achieving excellent elongation of the resulting rubber, the diallyl compound preferably contains diallyl phthalate.

When the rubber composition of the present invention further contains a diallyl compound, the content of the diallyl compound is preferably from 3.0 to 20 parts by mass, more preferably from 5.0 to 10.0 parts by mass, and still more preferably from 7.0 to 10.0 parts by mass per 100 parts by mass of the hydrogenated acrylonitrile butadiene rubber having an acrylonitrile content of 24 mass % or less, from the viewpoint of more excellent effect of the present invention.

### Silica

The rubber composition of the present invention may further contain silica.

When the rubber composition of the present invention further contains silica, examples of the silica that can be further contained in the rubber composition of the present invention include silica derived from the mixture when the peroxide is a mixture of peroxide and silica and silica added to the rubber composition of the present invention as silica alone (excluding the silica derived from the mixture when the peroxide is a mixture of peroxide and silica, and hereinafter, the same applies to silica alone). and hereinafter, the same applies to silica alone).

Silica in the mixture or silica as the silica alone is not particularly limited.

In the rubber composition of the present invention, the content of silica (for example, when peroxide is a mixture of peroxide and silica, the content of silica derived from the mixture, the content of silica as silica alone, or the total amount thereof, and hereinafter, the same applies to the content of silica) can be from 0 to 10 parts by mass per 100 parts by mass of the hydrogenated acrylonitrile butadiene rubber having an acrylonitrile content of 24 mass % or less. When the content of silica is within the above range, it has been confirmed that the excellent effect (durability under low temperature conditions) of the present invention can be maintained. In addition, in the present specification, it has been confirmed that the content of silica is within the above range, and in a case where a mixture of peroxide and silica is used as peroxide, both effects (durability under low temperature conditions) are equivalent even if silica alone is further used or not used.

When the rubber composition of the present invention further contains silica (for example, when peroxide is a mixture of peroxide and silica, silica derived from the mixture, silica as silica alone, or a combination thereof, and hereinafter, the same applies to silica), the content of silica is preferably from 1.0 to 5.0 parts by mass per 100 parts by mass of the hydrogenated acrylonitrile butadiene rubber having an acrylonitrile content of 24 mass % or less.

In the rubber composition of the present invention, the content of silica alone (excluding the silica derived from the mixture when the peroxide is a mixture of peroxide and silica) is preferably from 0 to 8 parts by mass, and more preferably from 0 to 3 parts by mass, and still more preferably 0 parts by mass per 100 parts by mass of the hydrogenated acrylonitrile butadiene rubber having an acrylonitrile content of 24 mass % or less.

The rubber composition according to an embodiment of the present invention can be a rubber composition containing substantially no sulfur. The rubber composition according to an embodiment of the present invention containing substantially no sulfur means the amount of the sulfur being from 0 to 0.5 mass % in the total amount of the rubber composition according to an embodiment of the present invention.

### (Production Method)

The production of the rubber composition according to an embodiment of the present invention is not particularly limited. Examples of the production method include a method for producing the rubber composition of the present invention by mixing the HNBR, carbon black, peroxide (the peroxide may be a mixture of peroxide and silica), magnesium oxide and additives that can be used as necessary under a condition of from 40 to 200° C. using a closed mixer such as a Banbury mixer or a kneader, or a kneading roll mill.

In the method for producing a rubber composition of the present invention, when the rubber composition of the present invention further contains silica (for example, when peroxide is a mixture of peroxide and silica, silica derived from the mixture, silica as silica alone, or a combination thereof), the content (use amount) of silica can be more than 0 parts by mass and 10 parts by mass or less and is preferably from 1.0 to 5.0 parts by mass per 100 parts by mass of the hydrogenated acrylonitrile butadiene rubber.

In the method for producing the rubber composition of the present invention, the content (use amount) of silica alone (excluding the silica derived from the mixture when the peroxide is a mixture of peroxide and silica) is preferably from 0 to 8 parts by mass, more preferably from 0 to 3 parts by mass, and still more preferably 0 parts by mass per 100 parts by mass of the hydrogenated acrylonitrile butadiene rubber.

The condition for crosslinking the rubber composition according to an embodiment of the present invention is not particularly limited. For example, the rubber composition of the present invention can be crosslinked while a pressure is applied in a condition at 140 to 160° C.

### Rubber Composition for Hose

The rubber composition according to an embodiment of the present invention can be used for production of a hose. In particular, an example of a preferable aspect is one in which the rubber composition of the present invention is used for an inner tube (innermost layer) of a hose.

Examples of the hose include a hose for an automobile, and specific examples thereof include piping (hose) used in a power steering system for an automobile.

### Hose

The hose according to the present invention is a hose produced using the rubber composition for a hose according to the present invention.

The rubber composition for a hose used in the hose according to the present invention is not particularly limited as long as it is the rubber composition of the present invention (the first rubber composition according to the present invention or the second rubber composition according to the present invention).

An example of a preferable aspect is one in which the hose according to the present invention includes an inner tube, a reinforcing layer, and an outer tube as constituent members. The hose according to the present invention may further include an intermediate rubber layer as a constituent member.

In the hose according to the present invention, the constituent member of the hose according to the present invention to which the rubber composition of the present invention is applied is not particularly limited, and from the viewpoint that the cured product obtained from the rubber composition of the present invention is excellent in durability under a low temperature condition, it is a preferable aspect that the hose according to the present invention has an inner tube formed using the rubber composition for a hose.

An example of the hose of the present invention will be described with reference to the accompanying drawings. However, the present invention is not limited to the attached drawings.

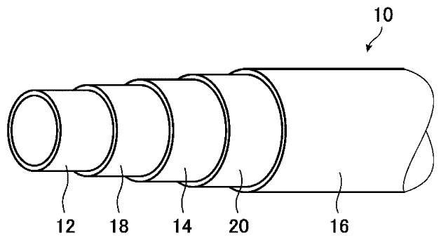

FIG. 1 is a schematic perspective view illustrating an example of a hose of the present invention with each layer cut out.

In FIG. 1, a hose 10 includes an inner tube 12, an intermediate rubber layer 14, and an outer tube 16, includes a reinforcing layer 18 between the inner tube 12 and the intermediate rubber layer 14, and includes a reinforcing layer 20 between the intermediate rubber layer 14 and the outer tube 16.

The inner tube 12 which is the innermost layer of the hose 10 is preferably formed of at least the rubber composition of the present invention.

In the hose according to the present invention, a thickness of the inner tube can be, for example, about from 0.5 to 5.0 mm, and is preferably from 0.8 to 3.0 mm.

The hose according to the present invention may include a reinforcing layer. The case where the hose according to an embodiment of the present invention has a reinforcing layer is preferred because tensile strength at break, usable pressure range, and metal mountability of the hose are enhanced. Examples of the reinforcing layer include structures in a blade form, helical form, net form, or film form. Examples of the material of the reinforcing layer include organic yarns (reinforcing yarns) such as aramid fibers, nylon, rayon, vinylon, and polyester; and metal wires such as brass-plated or zinc-plated steel wires.

In the hose according to the present invention, examples of a material that can form the outer tube (outermost layer) include a rubber composition containing a butyl rubber, a halogenated butyl rubber, an ethylene propylene rubber, a brominated isobutylene-p-methylstyrene copolymer rubber (BIMS), an ethylene-acrylic acid ester copolymer rubber (AEM), or the like.

A thickness of the outer tube is, for example, preferably from 0.5 to 5.0 mm, and more preferably from 0.8 to 3.0 mm.

The hose according to the present invention may optionally have an intermediate rubber layer. When the hose according to the present invention includes the intermediate rubber layer, the material of the intermediate rubber layer is not particularly limited as long as it is, for example, a rubber composition excellent in adhesion to the reinforcing layer.

The intermediate rubber layer can have a thickness of, for example, from 0.1 to 3 mm.

### (Method for Producing Hose According to Present Invention)

Examples of the method for producing the hose according to the present invention include a method, in which the rubber composition of the present invention in an unvulcanized state is disposed in a cylindrical form on a periphery of a mandrel or the like, a reinforcing layer is disposed on the periphery thereof, a rubber composition for an intermediate rubber layer is further disposed in a cylindrical form on the periphery thereof, a reinforcing layer is disposed on the periphery thereof, a rubber composition for an outer tube is further disposed in a cylindrical form on the periphery thereof, and then the entire hose is heated. The heating temperature is preferably 120° C. or higher, and more preferably from 140 to 170° C. After adequate cooling after heating, by removing from the mandrel, the hose according to the present invention can be obtained.

Examples of the application of the hose according to the present invention include a hose for an automobile, and specific examples thereof include piping (hose) used in a power steering system for an automobile.

The fluid passed through the inner portion of the hose according to an embodiment of the present invention is not particularly limited. Examples of the fluid include a fluid containing an oil having an aniline point of 90° C. or higher, and an example of a preferable aspect is a fluid containing an oil having an aniline point of 105° C. or higher.

### EXAMPLES

The present invention will be described in further detail below using examples.

Materials, used amounts, proportions, treatment details, treatment procedure, and the like described in the following examples can be appropriately modified without departing from the gist of an embodiment of the present invention. Thus, the scope of the present invention is not limited to the following examples.

### Production of Rubber Composition

Each of the components listed in Table 1 below were used in compositions (parts by mass) listed in the same table and mixed by an agitator, and thus each rubber composition was produced.

In the column of peroxide in Table 1, an upper row*¹ represents a total amount of a commercially available product used as peroxide, and a value in parentheses in a lower row*² represents a net amount of peroxide in the commercially available product. The commercially available product will be described below.

### Evaluation

The following evaluations were performed by using each rubber composition produced as described above. The results are listed in Table 1.

### Embrittlement Temperature

### Production of Sample

Each rubber composition produced as described above was vulcanized for 90 minutes at 160° C. under a surface pressure of 3.0 MPa using a press molding machine, a vulcanized sheet having a thickness of 2 mm was produced, and a strip-shaped sample having a length of from 26 to 40 mm and a width of 6 mm was cut out from the sheet.

### Low Temperature Impact Embrittlement Test

A low temperature impact embrittlement test was performed using the sample prepared as described above in accordance with Method B (50% impact embrittlement temperature) of JIS K6261-2:2017 to determine the 50% impact embrittlement temperature (unit: ° C.) of the sample. The 50% impact embrittlement temperature was indicated in the column of the embrittlement temperature in Table 1. In the present specification, the 50% impact embrittlement temperature is also simply referred to as the “embrittlement temperature”.

### Low Temperature Elastic Recovery Temperature (TR10)

### Production of Sample

Each rubber composition produced as described above was vulcanized for 90 minutes at 160° C. under a surface pressure of 3.0 MPa using a press molding machine, a vulcanized sheet having a thickness of 2 mm was produced, and an I-shaped sample was cut out from the sheet.

### Low Temperature Elasticity Recovery Test

By using each sample produced as described above, a low temperature elasticity recovery test was performed in accordance with ASTM D 1329, and a temperature (low temperature elastic recovery temperature, TR10) at which the elongation of each sample was recovered by 10% was measured.

The low temperature elastic recovery temperature (TR10, unit: ° C.) measured as described above islisted in the column of the low temperature elastic recovery temperature (TR10) in Table 1.

### (Embrittlement Temperature−Low Temperature Elastic Recovery Temperature)*³

The low temperature elastic recovery temperature (TR10) was subtracted from the embrittlement temperature using the embrittlement temperature and the low temperature elastic recovery temperature (TR10) measured as described above [(embrittlement temperature)−(low temperature elastic recovery temperature (TR10)], and a difference value (° C.) obtained was listed in the column of (embrittlement temperature−low temperature elastic recovery temperature)*³ in Table 1.

### Evaluation Criteria of Durability Under Low Temperature Condition

In the present invention, when the embrittlement temperature was −33° C. or lower and was also lower than the low temperature elastic recovery temperature (TR10) (that is, the difference value obtained by subtracting the low temperature elastic recovery temperature (TR10) from the embrittlement temperature was lower than 0° C.), the cured product obtained from the rubber composition was evaluated to have excellent durability under a low temperature condition.

As the embrittlement temperature is −33° C. or lower and the difference value obtained by subtracting the low temperature elastic recovery temperature (TR10) from the embrittlement temperature is smaller than 0° C., the durability is more excellent. (That is, as the embrittlement temperature is −33° C. or lower, the embrittlement temperature is lower than the low temperature elastic recovery temperature (TR10), and an absolute value of the difference value obtained by subtracting the low temperature elastic recovery temperature (TR10) from the embrittlement temperature is larger than 0, the durability is more excellent.)

TABLE 1

| | | Example | Example | Example | Example | Example | Example | Example |
|---|---|---|---|---|---|---|---|---|
| Table 1-1 | | 1 | 2 | 3 | 4 | 5 | 6 | 7 |
| HNBR1 | LT2007 | 100.0 | 100.0 | 100.0 | 100.0 | 100.0 | 100.0 | 100.0 |
| Comparative HNBR | AN content | | | | | | | |
| | 36 mass % | | | | | | | |
| Carbon black 1 | FEF | 40.0 | 40.0 | 40.0 | 40.0 | 40.0 | 40.0 | 40.0 |
| Carbon black 2 | SRF | 50.0 | 50.0 | 50.0 | 50.0 | 50.0 | 50.0 | 50.0 |
| Silica | | 5.0 | 5.0 | 5.0 | 5.0 | | 5.0 | |
| Magnesium oxide | | 9.0 | 9.0 | 9.0 | 9.0 | 2.5 | | |
| Zinc oxide | | 2.0 | 2.0 | 2.0 | 2.0 | 2.0 | 2.0 | 2.0 |
| Anti-aging agent | MBZ | 1.5 | 1.5 | 1.5 | 1.5 | 1.5 | 1.5 | 1.5 |
| Stearic acid | | 1.0 | 1.0 | 1.0 | 1.0 | 1.0 | 1.0 | 1.0 |
| Co-crosslinking agent 1 | TAIC (pure | 3.5 | 3.5 | 3.5 | 3.5 | 3.5 | 3.5 | 3.5 |
| | product) | | | | | | | |
| Co-crosslinking agent 2 | DAP | 8.0 | 8.0 | 8.0 | 8.0 | 8.0 | 8.0 | 8.0 |
| Peroxide | Upper row^{*1} | 5.5 | 5.0 | 4.5 | 3.0 | 8.5 | 8.5 | 8.5 |
| | Lower row^{*2} | (2.2) | (2.0) | (1.8) | (1.2) | (3.4) | (3.4) | (3.4) |
| Embrittlement temperature | ° C. | −35 | −35 | −37 | −39 | −33 | −34 | −34 |
| Low temperature elastic | ° C. | −29 | −29 | −29 | −28 | −31 | −30 | −30 |
| recovery temperature (TR10) | | | | | | | | |
| (Embrittlement | ° C. | −6 | −6 | −8 | −11 | −2 | −4 | −4 |
| temperature − low | | | | | | | | |
| temperature elastic | | | | | | | | |
| recovery temperature)^{*3} | | | | | | | | |

| | | Example | Example | Example | Example | Example | Example |
|---|---|---|---|---|---|---|---|
| Table 1-2 | | 8 | 9 | 10 | 11 | 12 | 13 |
| HNBR1 | LT2007 | 100.0 | 100.0 | 100.0 | 100.0 | 100.0 | 100.0 |
| Comparative HNBR | AN content | | | | | | |
| | 36 mass % | | | | | | |
| Carbon black 1 | FEF | 40.0 | 40.0 | 40.0 | 40.0 | 40.0 | 40.0 |
| Carbon black 2 | SRF | 50.0 | 50.0 | 50.0 | 50.0 | 50.0 | 50.0 |
| Silica | | | | 5.0 | 5.0 | | |
| Magnesium oxide | | | | | | 2.5 | 2.5 |
| Zinc oxide | | 2.0 | 2.0 | 2.0 | 2.0 | 2.0 | 2.0 |
| Anti-aging agent | MBZ | 1.5 | 1.5 | 1.5 | 1.5 | 1.5 | 1.5 |
| Stearic acid | | 1.0 | 1.0 | 1.0 | 1.0 | 1.0 | 1.0 |
| Co-crosslinking agent 1 | TAIC (pure | 3.5 | 3.5 | 3.5 | 3.5 | 3.5 | 3.5 |
| | product) | | | | | | |
| Co-crosslinking agent 2 | DAP | 8.0 | 8.0 | 8.0 | 8.0 | 8.0 | 8.0 |
| Peroxide | Upper row^{*1} | 5.0 | 3.0 | 5.0 | 3.0 | 5.0 | 3.0 |
| | Lower row^{*2} | (2.0) | (1.2) | (2.0) | (1.2) | (2.0) | (1.2) |
| Embrittlement temperature | ° C. | −38 | −44 | −38 | −44 | −37 | −43 |
| Low temperature elastic | ° C. | −29 | −28 | −29 | −28 | −29 | −28 |
| recovery temperature (TR10) | | | | | | | |
| (Embrittlement | ° C. | −9 | −16 | −9 | −16 | −8 | −16 |
| temperature − low | | | | | | | |
| temperature elastic | | | | | | | |
| recovery temperature)^{*3} | | | | | | | |

TABLE 3

| | | Comparative | Comparative | Comparative | Comparative | Comparative |
|---|---|---|---|---|---|---|
| Table 1-3 (part 1 of 2) | | Example 1 | Example 2 | Example 3 | Example 4 | Example 5 |
| HNBR1 | LT2007 | 100.0 | 100.0 | 100.0 | 100.0 | 100.0 |
| Comparative HNBR | AN content | | | | | |
| | 36 mass % | | | | | |
| Carbon black 1 | FEF | 40.0 | 40.0 | 40.0 | 40.0 | 40.0 |
| Carbon black 2 | SRF | 50.0 | 50.0 | 50.0 | 50.0 | 50.0 |
| Silica | | 5.0 | | 5.0 | | |
| Magnesium oxide | | 10.0 | 10.0 | 5.0 | 6.0 | 5.0 |
| Zinc oxide | | 2.0 | 2.0 | 2.0 | 2.0 | 2.0 |
| Anti-aging agent | MBZ | 1.5 | 1.5 | 1.5 | 1.5 | 1.5 |
| Stearic acid | | 1.0 | 1.0 | 1.0 | 1.0 | 1.0 |
| Co-crosslinking agent 1 | TAIC (pure | 3.5 | 3.5 | 3.5 | 3.5 | 3.5 |
| | product) | | | | | |
| Co-crosslinking agent 2 | DAP | 8.0 | 8.0 | 8.0 | 8.0 | 8.0 |
| Peroxide | Upper row^{*1} | 8.5 | 8.5 | 8.5 | 8.5 | 8.5 |
| | Lower row^{*2} | (3.4) | (3.4) | (3.4) | (3.4) | (3.4) |
| Embrittlement temperature | ° C. | −30 | −30 | −30 | −30 | −30 |
| Low temperature elastic | ° C. | −30 | −30 | −30 | −31 | −31 |
| recovery temperature (TR10) | | | | | | |
| (Embrittlement | ° C. | 0 | 0 | 0 | 1 | 1 |
| temperature − low | | | | | | |
| temperature elastic | | | | | | |
| recovery temperature)^{*3} | | | | | | |

| | | Comparative | Comparative | Comparative | Comparative |
|---|---|---|---|---|---|
| Table 1-3 (part 2 of 2) | | Example 6 | Example 7 | Example 8 | Example 9 |
| HNBR1 | LT2007 | 100.0 | 100.0 | | |
| Comparative HNBR | AN content | | | 100.0 | 100.0 |
| | 36 mass % | | | | |
| Carbon black 1 | FEF | 40.0 | 40.0 | 40.0 | 40.0 |
| Carbon black 2 | SRF | 50.0 | 50.0 | 50.0 | 50.0 |
| Silica | | | | | 5.0 |
| Magnesium oxide | | | 3.0 | | 9.0 |
| Zinc oxide | | 2.0 | 2.0 | 2.0 | 2.0 |
| Anti-aging agent | MBZ | 1.5 | 1.5 | 1.5 | 1.5 |
| Stearic acid | | 1.0 | 1.0 | 1.0 | 1.0 |
| Co-crosslinking agent 1 | TAIC (pure | 3.5 | 3.5 | 3.5 | 3.5 |
| | product) | | | | |
| Co-crosslinking agent 2 | DAP | 8.0 | 8.0 | 8.0 | 8.0 |
| Peroxide | Upper row^{*1} | 10 | 10 | 5.0 | 5.0 |
| | Lower row^{*2} | (4.0) | (4.0) | (2.0) | (2.0) |
| Embrittlement temperature | ° C. | −31 | −30 | −31 | −28 |
| Low temperature elastic | ° C. | −30 | −29 | −20 | −20 |
| recovery temperature (TR10) | | | | | |
| (Embrittlement | ° C. | −1 | −1 | −11 | −8 |
| temperature − low | | | | | |
| temperature elastic | | | | | |
| recovery temperature)^{*3} | | | | | |

Details of each of the components listed in Table 1 are as follows.

### (HNBR)

HNBR1 LT2007: Hydrogenated acrylonitrile butadiene rubber. Trade name: THERBAN LT 2007, available from ARLANXEO. AN content: 21 mass %, hydrogenation percentage: 99%
Comparative HNBR: Hydrogenated acrylonitrile butadiene rubber. Trade name: ZETPOL 2000L, available from Zeon Corporation. AN content: 36 mass %, hydrogenation percentage: 99%

### (Carbon Black)

Carbon black 1 FEF: FEF carbon black (available from Nippon Steel Carbon Co., Ltd.); nitrogen adsorption specific surface area: 41 m²/g; dibutyl phthalate oil absorption: 121 mL/100 g
Carbon black 2 SRF: SRF carbon black (trade name: Niteron #S, available from NSCC Carbon Co., Ltd.); nitrogen adsorption specific surface area: 25 m²/g; dibutyl phthalate oil absorption: 72 mL/100 g
Silica: Nipsil AQ available from Tosoh Silica Corporation
Magnesium oxide: Kyowamag 150 available from Kyowa Chemical Industry Co., Ltd.
Zinc oxide: Zinc Oxide III available from Seido Chemical Industry Co., Ltd.
Anti-aging agent MBZ: 2-mercaptobenzimidazole. NOCRAC MBZ available from Ouchi Shinko Chemical Industrial Co., Ltd.
Stearic acid: Lunac YA available from Kao Corporation
Co-crosslinking agent 1 TAIC (pure product): triallyl isocyanurate. Trade name: TAIC available from Nihon Kasei Co., Ltd.
Co-crosslinking agent 2 DAP: Diallyl phthalate available from Daiso Co., Ltd.

### (Peroxide)

Crosslinking agent: Perkadox 14-40 (trade name) available from Kayaku Akzo Corporation The commercially available product is a mixture of di(t-butylperoxydiisopropyl)benzene and silica, and in the commercially available product, the content of di(t-butylperoxydiisopropyl)benzene is 40 mass %, and the content of silica is 60 mass %.

It was confirmed that the rubber composition of the present invention achieved the desired effects from the results of Table 1.

Examples 1 to 4 and 8 to 13 qualify as the first rubber composition according to the present invention.

Examples 5 to 13 qualify as the second rubber composition according to the present invention.

On the other hand, Comparative Examples 1 and 2, in which the content of magnesium oxide per 100 parts by mass of the predetermined HNBR was 10 parts by mass, did not qualify as the rubber composition of the present invention, and did not satisfy the criteria for durability under a low temperature condition.

Comparative Examples 3 to 5, in which the net content of peroxide per 100 parts by mass of the predetermined HNBR was 3.4 parts by mass and the content of magnesium oxide per 100 parts by mass of the predetermined HNBR was 5 or 6 parts by mass, did not qualify as the rubber composition of the present invention, and did not satisfy the criteria for durability under a low temperature condition.

Comparative Examples 6 to 7, in which the net content of peroxide per 100 parts by mass of the predetermined HNBR was more than 3.5 parts by mass, did not qualify as the rubber composition of the present invention, and did not satisfy the criteria for durability under a low temperature condition.

Comparative Examples 8 to 9, which did not contain the predetermined HNBR but contained hydrogenated acrylonitrile butadiene rubber with an acrylonitrile content of more than 24 mass %, did not qualify as the rubber composition of the present invention, and did not satisfy the criteria for durability under a low temperature condition.

Since the rubber compositions in Examples 1 to 13 and Comparative Examples 1 to 7 had the same rubber components, their low temperature elastic recovery temperatures (TR10) were substantially the same, and a clear difference in durability under a low temperature condition was not confirmed from the low temperature elastic recovery temperatures (TR10) only.

### REFERENCE SIGNS LIST

10 Hose
12 Inner tube
14 Intermediate rubber layer
16 Outer tube
18, 20 Reinforcing layer

1. A rubber composition for a hose, comprising:
a hydrogenated acrylonitrile butadiene rubber having an acrylonitrile content of 24 mass % or less; a carbon black; and a peroxide,
a content of the peroxide being 1.0 part by mass or more and less than 2.4 parts by mass per 100 parts by mass of the hydrogenated acrylonitrile butadiene rubber, and
a content of magnesium oxide being 0 parts by mass or more and less than 10.0 parts by mass per 100 parts by mass of the hydrogenated acrylonitrile butadiene rubber.

2. A rubber composition for a hose, comprising:
a hydrogenated acrylonitrile butadiene rubber having an acrylonitrile content of 24 mass % or less; a carbon black; and a peroxide,
a content of the peroxide being from 1.0 to 3.5 parts by mass per 100 parts by mass of the hydrogenated acrylonitrile butadiene rubber, and
a content of magnesium oxide being from 0 to 3.0 parts by mass per 100 parts by mass of the hydrogenated acrylonitrile butadiene rubber.

3. The rubber composition for a hose according to claim 2, wherein the content of the peroxide is from 1.0 to 2.4 parts by mass per 100 parts by mass of the hydrogenated acrylonitrile butadiene rubber.

4. A hose produced by using the rubber composition for a hose according to claim 1.

5. The hose according to claim 4, which is a hose for an automobile.

6. The hose according to claim 4, which is piping of a power steering system for an automobile.

7. A hose produced by using the rubber composition for a hose according to claim 2.

8. The hose according to claim 7, which is a hose for an automobile.

9. The hose according to claim 7, which is piping of a power steering system for an automobile.
